(19) United States
(12) Patent Application Publication
(10) Pub. No.: US 2011/0241521 A1
(43) Pub. Date: Oct. 6, 2011

(54) SPARK PLUG ELECTRODE AND METHOD OF MANUFACTURE

(75) Inventors: Nicholas C. Polcyn, Commerce, MI (US); Jeongung Hwang, Northville, MI (US)

(73) Assignees: DENSO INTERNATIONAL AMERICA, INC., Southfield, MI (US); DENSO CORPORATION, Kariya-Shi (JP)

(21) Appl. No.: 12/749,883

(22) Filed: Mar. 30, 2010

(51) Int. Cl. H01T 13/20; H01T 21/02

(52) U.S. Cl. 313/141; 445/7

(57) ABSTRACT

A spark plug for an internal combustion engine includes a housing having a distal end, a proximal end, and an outer periphery extending therebetween. A mounting thread formed on the outer periphery at the proximal end of the housing secures the spark plug to the engine. A center electrode fixedly secured along a central axis of the housing has a first end extending outwardly from the proximal end of the housing. A ground electrode secured to the proximal end of the housing has an electrode tip at a first distance from the center electrode. The electrode tip has a central aperture extending through the ground electrode from an upper surface to a lower surface. A protruding edge circumscribes the aperture and extends a second distance from the upper surface of the electrode tip towards the center electrode.

### FIELD

The present disclosure relates to spark plugs for internal combustion engines and, more particularly, to a spark plug for use in a motor vehicle, co-generation system, or gas feed pump.

### BACKGROUND

This section provides background information related to the present disclosure which is not necessarily prior art. Spark plugs have long been used as igniting means for internal combustion engines of motor vehicles or the like. The spark plug typically includes a center electrode and a ground electrode between which a sparking gap is provided. By applying a high voltage across the center electrode and the ground electrode, a spark discharge takes place in the sparking gap, thereby igniting an air-fuel mixture within the combustion engine.

In recent years and due to an increasing demand for low fuel consumption and high power output, modern motor vehicles generally employ direct fuel-injection type engines each arranged to directly inject fuel into a combustion chamber of the engine. Therefore, the air-fuel mixture supplied to the combustion chamber tends to have an increased concentration of fuel near the spark plug.

In such an arrangement, excess fuel of the air-fuel mixture adheres onto the ground electrode at areas around the sparking gap. Fuel adhered onto the surface of the ground electrode results in some common, problematic issues, such as fuel clamping and fuel bridging. In fuel clamping, fuel flows along the ground electrode surface to a facing surface of the center electrode, congealing therebetween. This problem of fuel of the air-fuel mixture to congeal at the facing surface of the ground electrode increases exponentially over time as engine components wear.

Another common issue is fuel bridging, which occurs when the excess fuel of the air-fuel mixture at the ground electrode surface “bridges” across the sparking gap. Bridging across the sparking gap involves making a connection between the center electrode and the facing surface of the ground electrode causing the spark plug to “short circuit” and misfire. Such issues become especially problematic when starting the engine in an extremely low temperature environment (i.e., fuel is more viscous), which causes fuel clamping and bridging to occur at increased incidence rates.

Attempts to alleviate these problems have included providing spark plugs with center and ground electrodes carrying noble metal chips thereon. The noble metal chips were formed in respective narrowed outer diameters for suppressing the occurrence of fuel bridging (see Japanese Unexamined Patent Application Publication No. 2001-307858). However, even when employing such a spark plug design, the spark plug can still suffer the occurrence of fuel clamping. Further, the addition of noble metal chips in the spark plug design results in increased production time and cost.

### SUMMARY

This section provides a general summary of the disclosure, and is not a comprehensive disclosure of its full scope or all of its features. A spark plug for an internal combustion engine includes a housing having a distal end, a proximal end, and an outer periphery extending therebetween. A mounting thread formed on the outer periphery at the proximal end of the housing secures the spark plug to the engine. A center electrode fixedly secured along a central axis of the housing has a first end extending outwardly from the proximal end of the housing. A ground electrode secured to the proximal end of the housing has an electrode tip at a first distance from the center electrode. The electrode tip has a central aperture extending through the ground electrode from an upper surface to a lower surface. A protruding edge circumscribes the aperture and extends a second distance from the upper surface of the electrode tip towards the center electrode.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a partial cross-sectional view of a direct-injection engine cylinder according to the present invention;

FIG. 2 is a partial cross-sectional view of a spark plug according to the present invention;

FIG. 3 is a perspective view of a first embodiment of a ground electrode according to the present invention;

FIGS. 4 through 7 are perspective views of the ground electrode of FIG. 3 during a forming process;

FIG. 8 is a perspective view of a second embodiment of a ground electrode according to the present invention;

FIG. 9 is an isometric view of the ground electrode of FIG. 8; and

FIG. 10 is a perspective view of the ground electrode of FIG. 8 during a forming process, similar to that shown in FIG. 5.

Corresponding reference numerals indicate corresponding parts throughout the several views of the drawings.

### DETAILED DESCRIPTION

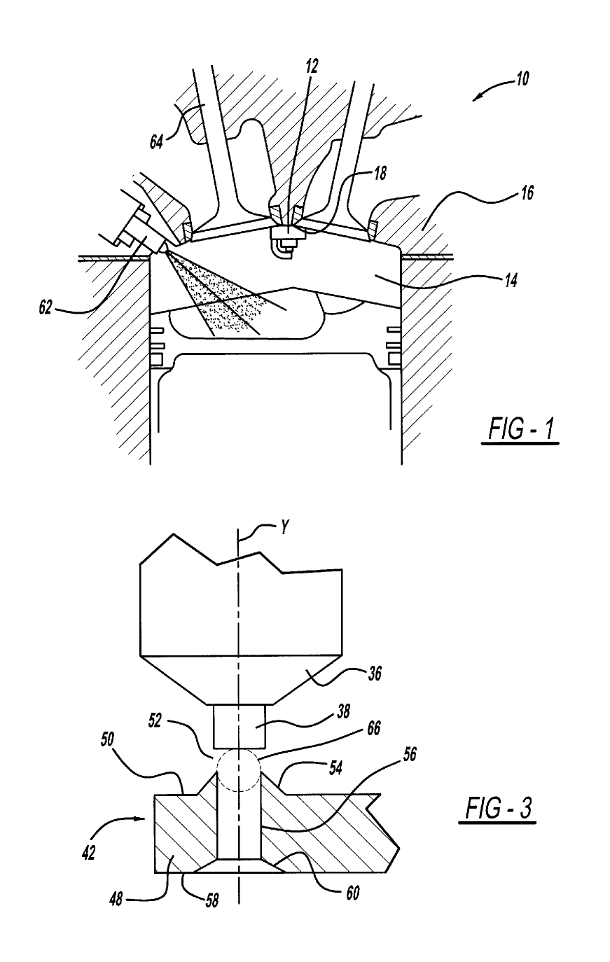

Example embodiments will now be described more fully with reference to FIGS. 1-10 of the accompanying drawings. It should be understood that throughout the drawings, corresponding reference numerals indicate like or corresponding parts and features. Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies will not be described in detail.

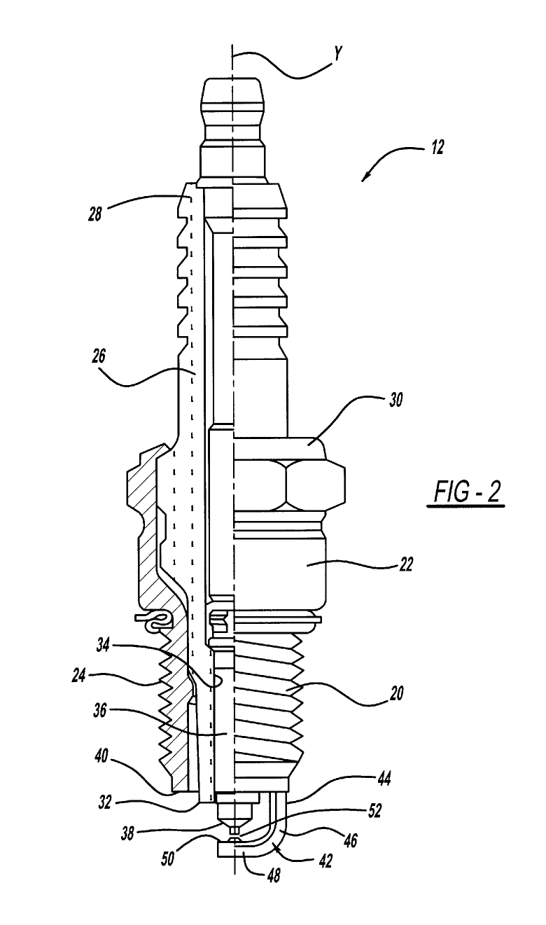

Referring now to FIGS. 1 and 2, an internal combustion engine 10 of a motor vehicle, a cogeneration system, or a gas pressure feed pump may use a spark plug 12 as an igniting means for initiating combustion within the combustion chamber 14. The engine 10 typically includes an engine block 16 having a threaded bore 18 for receiving mounting threads 20 of the spark plug 12.

The spark plug 12 may include a cylindrical metal housing 22, which may be made of electrically conductive steel (e.g., low carbon steel). The housing 22 withstands the torque of tightening the spark plug 12 into the engine block 16, removes excess heat from the spark plug 12, and disperses the excess heat to the engine block 16. The mounting threads 20 are formed as a lower portion 24 of the housing 22 for attachment into the engine block 16. The housing 22 may contain a porcelain insulator 26 (e.g., an alumina ceramic), which is fixedly and coaxially supported within the housing 22 along a central axis Y. The insulator 26 may include a distal end 28 that protrudes outwardly from an upper portion 30 of the housing 22 and a proximal end 32 that protrudes outwardly from the mounting threads 20. The length of the insulator 26 may be modified to provide an appropriate length for the spark plug 12 per engine design, such that it is more readily accessible for service.

The insulator 26 may also include an axial bore 34 for fixedly retaining a center electrode 36 in an electrically insulated state. A first end 38 of the center electrode 36 may protrude from the proximal end 32 of the insulator 26 such that the center electrode 36 protrudes a predetermined distance from a tip portion 40 of the housing 22.

With reference now to FIGS. 2 and 3, a ground electrode 42 may also extend from the tip portion 40 of the housing 22. The ground electrode 42 may take the form of a rectangular columnar configuration, which may have a fixed end 44 secured to the tip portion 40 of the housing 22 by welding, a middle portion 46 bent in a substantially L-shaped configuration, and an electrode tip 48 laterally extending from the middle portion 46. The electrode tip 48 may include an upper surface 50 arranged in a face-to-face (e.g. opposing) relationship with the first end 38 of the center electrode 36 at a predetermined distance, commonly referred to as a sparking gap 52. The electrode tip 48 may also include a sharp edge 54 extending uniformly away from the upper surface 50. The sharp edge 54 may take the form of a burr or an extended chamfer, for example. The sharp edge 54 may surround a central aperture 56, which extends through the electrode tip 48 to an undersurface 58 of the electrode tip 48. The undersurface 58 of the electrode tip 48 may define a chamfered countersink 60 at a location surrounding the central aperture 56. The central aperture may include a protruding edge circumscribing the aperture and extending a second distance from the upper surface of the electrode tip towards the center electrode.

Operation of the spark plug 12 will now be described with reference to FIGS. 1 through 3. A fuel injector 62 and a valve 64 are opened to supply a specified air-fuel ratio to the combustion chamber 14. A voltage is then applied across the center electrode 36 and the electrode tip 48 of the ground electrode 42, creating a plasma arc (not shown) in the sparking gap 52. This spark discharge ignites the air-fuel mixture, which is initiated as a flame kernel form 66 as best shown in FIG. 3. When ignition takes place, the air-fuel mixture adhered onto the upper surface 50 of the ground electrode 42 is consumed by the flame kernel form 66.

In excessive fuel conditions, however, such as is found with direct fuel-injection type engines, fuel has a tendency to flow out of the sparking gap 52 into an area away from the reach of the flame kernel form 66 (e.g., onto the middle portion 46 of the ground electrode 42). This excess fuel may gather between the center and ground electrodes 36, 42 resulting in an unfavorable condition, such as fuel bridging or fuel clamping, which may cause misfiring of the spark plug 12. While larger electrode arrangements may produce larger flame kernel forms for consuming this excess fuel, these larger electrode arrangements are more costly, require a higher voltage, and tend to have an increased cooling effect, which may cause ignition to stop short.

The central aperture 56 of the ground electrode 42, however, reduces the necessity for such larger electrode arrangements. The central aperture 56 creates a perforation inside of the ground electrode 42 having the sharp edge 54 around the perimeter for attracting the plasma arc as a grounding point during the ignition sparking process. Such an arrangement allows for a larger electro-magnetic field (EMF) at the sharp edge 54 of the ground electrode 42.

Additionally, the removal of material at the central aperture 56 provides an alternative channel for the flame kernel form 66 to grow. As the flame front of the flame kernel form 66 can now travel vertically, a larger amount of the air/fuel mixture can be ignited in a shorter amount of time, resulting in higher ignitability, improved fuel economy, faster light off times, and better emissions. Further, the central aperture 56 creates a drainage channel for excess fuel, which eliminates the concern of fuel pooling on the ground electrode 42.

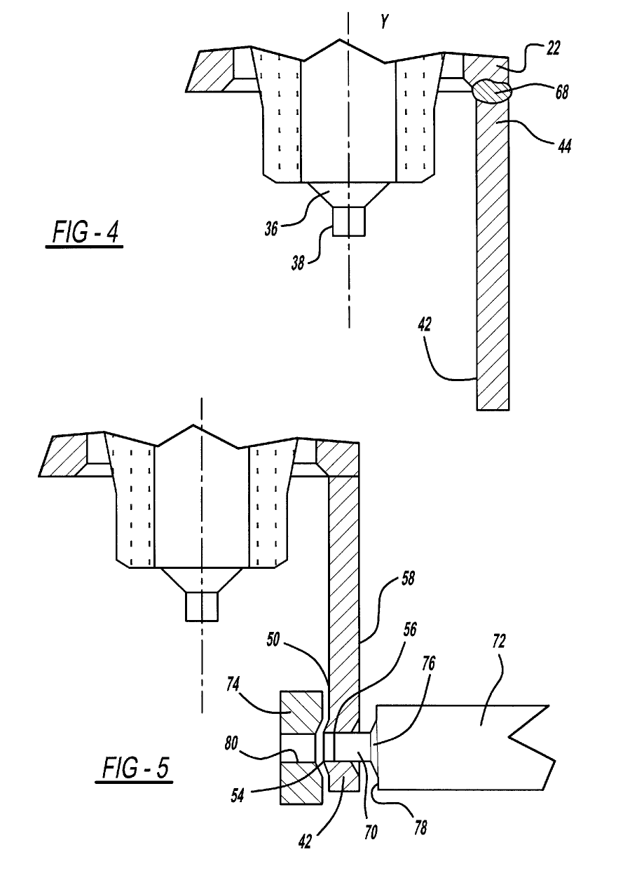

A process for forming the ground electrode 42 portion of the present invention will now be described with reference to FIGS. 4 through 7. In an initial operation, the ground electrode 42 is secured to the housing 22 at the fixed end 44 of the ground electrode 42 through a weld 68 while the ground electrode 42 remains in an extended/elongated and unperforated state (FIG. 4). In one example, the ground electrode 42 is fastened to the housing 22 by either resistance welding or laser welding.

Next as shown in FIG. 5, the undersurface 58 of the ground electrode 42 is brought into contact with an extended portion 70 of a perforation tool 72 (i.e., a punch) while the upper surface 50 is supported by a die form 74 (i.e., a jig). The perforation tool 72 typically includes a chamfered edge 76 between the extended portion 70 and a top surface 78 of the tool 72 for increased strength in the extended portion 70. Additionally, the chamfered edge 76 increases material movement into the die form 74 so as to achieve the requisite shape for the sharp edge 54. The chamfered edge 76 corresponds to the chamfered countersink 60.

The perforation tool 72 is then pressed through the ground electrode 42 and into a corresponding aperture 80 in the die form 74, thereby removing material from the central aperture 56. As can be understood, the size and shape of the interaction between the perforation tool 72 and the die form 74 may be varied to control the dimensions of the sharp edge 54 at the upper surface 50 of the ground electrode 42.

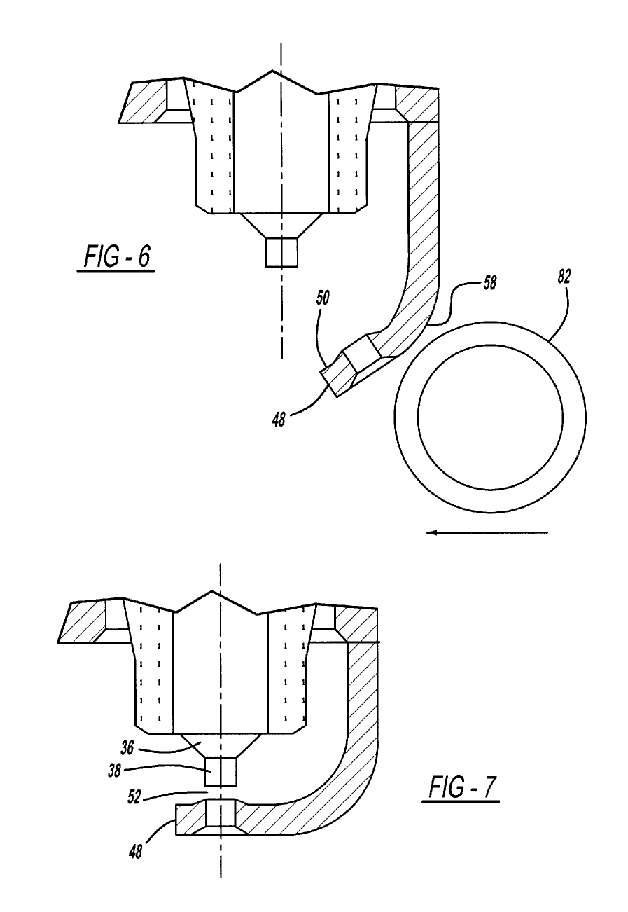

Finally as shown in FIG. 6, the ground electrode 42 is subjected to a bending operation by running a roller 82 against the undersurface 58 of the electrode tip 48. The roller 82 bends the ground electrode 42 until the upper surface 50 of the ground electrode 42 is properly adjusted to provide the aforementioned sparking gap 52 (FIG. 7).

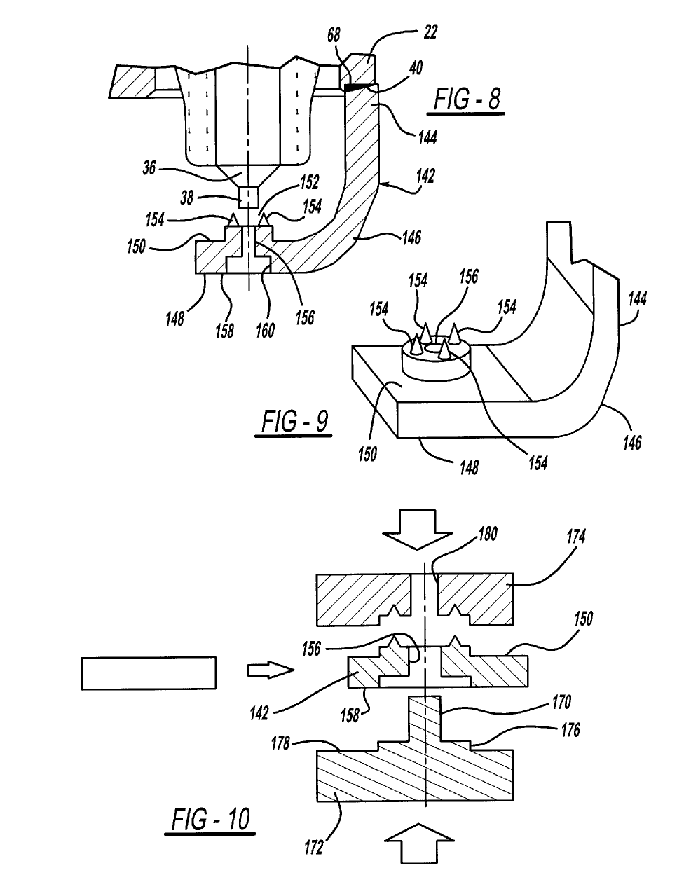

Another embodiment of the present invention will now be described with reference to FIGS. 8 through 10. In these various figures, a ground electrode 142 extends from the housing 22 similarly to the ground electrode 42 as previously described with reference to FIGS. 1 through 7. The multiple sharp spikes 154 of the present embodiment, however, operate to share the load, thereby extending the life of the ground electrode 142.

Referring now to FIGS. 8 and 9, the ground electrode 142 may take the form of a rectangular columnar configuration, which may have a fixed end 144 secured to the tip portion 40 of the housing 22 by a weld 68, a middle portion 146 bent in a substantially L-shaped configuration, and an electrode tip 148 laterally extending from the middle portion 146. The electrode tip 148 may include an upper surface 150 arranged in a face-to-face relationship with the first end 38 of the center electrode 36 at a predetermined distance, commonly referred to as a sparking gap 152. The electrode tip 148 may also include a plurality of sharp spikes 154 extending uniformly away from the upper surface 150. The sharp spikes 154 may be evenly dispersed around a central aperture 156, which extends through the electrode tip 148 to an undersurface 158 of the electrode tip 148. The undersurface 158 of the electrode tip 148 may define a countersink 160 at a location surrounding the central aperture 156.

The process for forming the ground electrode 142 portion of the second embodiment is substantially similar to that of the ground electrode 42 of the first embodiment and will not be described in detail herein. As can be seen in FIG. 10, however, the modified design of the ground electrode 142 may require an alternate design perforation tool 172 and die form 174. The undersurface 158 of the ground electrode 142 is brought into contact with an extended portion 170 of the perforation tool 172 (e.g., a punch) while the upper surface 150 is supported by a die form 174 (e.g., a jig). The perforation tool 172 typically includes a squared edge 176 between the extended portion 170 and a top surface 178 of the tool 172 for increased strength in the extended portion 170. Additionally, the squared edge 176 increases material movement into the die form 174 so as to achieve the requisite shape for the sharp spikes 154. The squared edge 176 corresponds to the countersink 160.

The perforation tool 172 is then pressed through the ground electrode 142 and into a corresponding aperture 180 in the die form 174, thereby removing material from the central aperture 156. As can be understood, the size and shape of the interaction between the perforation tool 172 and the die form 174 may be varied to control the dimensions of the sharp spikes 154 at the upper surface 150 of the ground electrode 142.

As the upper surface 50, 150 of the ground electrode 42, 142 has a smaller surface area, fuel is forced to flow out of the sparking gap 52, 152 and into areas away from the ground electrode 42, 142. This prevents fuel from clamping and bridging on the upper surface 50, 150 of the ground electrode 42, 142, which in turn, improves ignitability and startability (i.e sparkability) of the spark plug 12 leading to a longer operating life.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

What is claimed is:

1. A spark plug for an internal combustion engine, comprising:
a housing having a distal end, a proximal end, and an outer periphery extending therebetween;
a mounting thread formed on the outer periphery at the proximal end of the housing, the spark plug fixedly secured to the engine through the mounting thread;
a center electrode fixedly secured along a central axis of the housing, the center electrode having a first end extending outwardly from the proximal end of the housing; and
a ground electrode secured to the proximal end of the housing and having an electrode tip at a first distance from the center electrode,
wherein the electrode tip includes a central aperture extending through the ground electrode from an upper surface of the electrode tip to a lower surface of the electrode tip,
wherein the central aperture includes a protruding edge circumscribing the aperture and extending a second distance from the upper surface of the electrode tip towards the center electrode.

2. The spark plug according to claim 1 wherein the housing is an electrically conductive steel.

3. The spark plug according to claim 2 wherein the housing is a low carbon steel.

4. The spark plug according to claim 1 further comprising an insulator fixedly secured within the housing along the central axis of the housing.

5. The spark plug according to claim 4 wherein the insulator is a porcelain.

6. The spark plug according to claim 5 wherein the insulator is an alumina ceramic.

7. The spark plug according to claim 4 wherein the insulator fixedly retains the center electrode in an electrically insulated state.

8. The spark plug according to claim 1 wherein the proximal end of the center electrode is in a face-to-face relationship with the upper surface of the ground electrode.

9. A spark plug for an internal combustion engine, comprising:
a housing having a distal end, a proximal end, and an outer periphery extending therebetween;
a mounting thread formed on the outer periphery at the proximal end of the housing, the spark plug fixedly secured to the engine through the mounting thread;
an insulator fixedly secured within the housing along a central axis of the housing;
a center electrode retained within the insulator, the center electrode having a first end extending outwardly from the proximal end of the housing; and
a ground electrode secured to the proximal end of the housing and having an electrode tip at a first distance from the center electrode,
wherein the electrode tip includes a central aperture extending through the ground electrode from an upper surface of the electrode tip to a lower surface of the electrode tip,
wherein the central aperture includes a plurality of protruding spikes circumscribing the aperture and extending a second distance from the upper surface of the electrode tip towards the center electrode.

10. The spark plug according to claim 9 wherein the housing is an electrically conductive steel.

11. The spark plug according to claim 10 wherein the housing is a low carbon steel.

12. The spark plug according to claim 9 wherein the insulator is a porcelain.

13. The spark plug according to claim 12 wherein the insulator is an alumina ceramic.

14. The spark plug according to claim 9 wherein the insulator fixedly retains the center electrode in an electrically insulated state.

15. The spark plug according to claim 9 wherein the proximal end of the center electrode is in a face-to-face relationship with the upper surface of the ground electrode.

16. A method of manufacturing a spark plug having an outer, cylindrical housing comprising:
welding a ground electrode to a lower portion of the housing at a first end of the ground electrode;
presenting a first surface of the ground electrode with a perforation tool and a second surface of the ground electrode parallel to the first surface with a die form having a central aperture and at least one sharp edge;
punching the ground electrode with the perforation tool so as to bring the perforation tool into contact with the central aperture of the die form;
removing the ground electrode from the perforation tool and die form; and
bending a second end of the ground electrode such that an upper surface of the ground electrode is in a spaced apart, face-to-face relationship with the lower portion of the housing.

17. The method according to claim 16 further comprising:
moving a portion of the ground electrode material into the at least one sharp edge.

18. The method according to claim 17 wherein an elongate portion of the perforation tool extends into the central aperture of the die form during punching.

19. The method according to claim 18 wherein the perforation tool further comprises a chamfered feature at a base of the elongate portion for moving the portion of the ground electrode material into the at least one sharp edge.

20. The method according to claim 16 wherein the perforation tool further comprises a plurality of sharp edges.
